(19) United States
(12) Patent Application Publication
(10) Pub. No.: US 2005/0219139 A1
(43) Pub. Date: Oct. 6, 2005

(54) Antenna coil

(75) Inventors: Satoru Kimura, Turugashima-shi (JP); Junichi Sato, Turugashima-shi (JP); Hidehito Uchida, Yokohama-shi (JP)

Correspondence Address: JORDAN AND HAMBURG LLP, 122 EAST 42ND STREET, SUITE 4000, NEW YORK, NY, 10168, US

(73) Assignees: TOKO CO., LTD., Turugashima-shi (JP); ALPHA CO., LTD., Yokohama-shi (JP)

(21) Appl. No.: 11/034,911

(22) Filed: Jan. 12, 2005

(30) Foreign Application Priority Data
Apr. 6, 2004 (JP) 2004-111734

(51) Int. Cl. H01Q 7/08

(52) U.S. Cl. 343/788; 343/787

(57) ABSTRACT

To provide an antenna coil, which is used to attach on a doorknob, door mirror and in particular on a handle and the like as a keyless entry device for a vehicle, which is simple in structure, cheap and miniature type with reliability on external connection and the like, in order to satisfy requirements for improvement of the reliability on external connection, miniaturization and environmental performances for shock, vibration, temperature and humidity. The antenna coil is provided with a thin bar-shaped core, a flat, recessed and insulated bobbin of which one side is open, and an insulated exterior case, with a recessed cross section on one side which is bigger than the bobbin and is open, stores the core in a recessed part of the bobbin, is provided with coil (lead) in which winding is provided on the winding groove formed in bobbin, stores coil in recessed part of exterior case and fills adhesive made of resin with high flexibility.

### BACKGROUND OF THE INVENTION

1. Field of the Invention

This invention relates to a miniature antenna coil using an induction magnetic field to be utilized in a keyless entry device such as a door handle, a door mirror and the like in a vehicle.

2. Description of the Prior Art

As a conventional keyless entry device in a vehicle, a device in which a remote unit transmits radio wave with a prescribed code when an operator operates a button in a remote unit and locks or unlocks a door of the vehicle when the code coincides with the specified code registered in the vehicle side previously is common. Also, a device in which a door of the vehicle can be unlocked automatically only when a driver carrying a remote unit with him approaches to the vehicle without operating a button and a door of the vehicle can be locked automatically when the driver gets out and leaves from the vehicle is known recently in this type of the device.

The keyless entry device of the vehicle is provided with the first antenna coil 27 in a remote unit A side, and transmitter 28 and first control circuit 29 to transmit a prescribed signal to transmitter 28 based on electric current from the first antenna coil 27 on remote unit A, which transmits and receives radio wave between unit A and the vehicle and locks and unlocks the door of the vehicle according to the radio wave as shown in FIG. 3. Battery 30 to supply electric power to transmitter 28 and the first control circuit 29 is provided. The second antenna coil 31 and feeding circuit 32, which supplies electric power to the second antenna coil 31 and to transmit an electromagnetic wave for activation of the remote unit and receiver 33 to receive the prescribed signal from transmitter 28 are provided on the vehicle mounting side unit B, which controls feeding circuit 32 to supply electric power to the second antenna coil 31. When the first antenna coil 27 is in a fixed range to the second antenna coil 31, that is to say, when the scope of magnetic field is within about 1 m from the second antenna coil 31, the electromagnetic wave to activate the remote unit, which enables electromagnetic inductive coupling with the first antenna coil 27 is transmitted. The device is also provided with the second control circuit 34, which locks and unlocks the door of the vehicle based on the prescribed signal from receiver 33 and automatic locking timer 35 and timer 36, human body detection sensor 37 in the vehicle and door lock device driving circuit 38 to drive the door lock device for locking and unlocking the door of the vehicle, which are attached on a portable item to carry the remote unit A always.

In this way, the second control circuit 34 controls feeding circuit 32 to supply electric power to the second antenna coil 31 and to transmit the electromagnetic wave for activation of the remote unit. The first control circuit 29 activates transmitter 28 to transmit the prescribed signal based on electric current from the first antenna coil 27, which received the electromagnetic wave to activate the remote unit. And, the second control circuit 34 locks and unlocks the door of the vehicle based on the prescribed signal from receiver 33 on vehicle mounting side unit A, which received this prescribed signal. Accordingly, when the first antenna coil 27 is in a fixed range to the second antenna coil 31, the first control circuit 29 receives electric current from the first antenna coil 27 as an activation signal to activate the first control circuit 29 and activates transmitter 28 for the first time receiving this signal. After transmitter 28 is activated, battery 30 in remote unit A is used only for the stand-by power necessary for stand-by to receive electric power from the first antenna coil 27 in the first control circuit 29 and so the consumption of battery 30 can be reduced. The keyless entry device can be carried always by attaching remote unit A on the portable item. And this keyless entry device is disclosed in Patent Document 1.

The second antenna coil 31 on the vehicle mounting side is usually attached on the handle of the doorknob in the conventional keyless entry device in the vehicle.

Also, an antenna coil using a bar antenna attached on the door handle is disclosed in Patent Document 2 as an antenna coil for keyless. The disclosed antenna coil had a single core made of thin bar-shaped ferromagnetic substance with the winding and the core and a bobbin wrapping the core are contained in a storing case and the opening between the core and the bobbin and the opening between the bobbin and the case are filled with potting material to prevent damage of the single core unit and deterioration by temperature, humidity and the like.
[Patent Document 1] JP2001-115700 Publication of unexamined patent applications
[Patent Document 2] JP2001-358522 Publication of unexamined patent applications

### SUMMARY OF THE INVENTION

The antenna coil in a keyless entry device for a vehicle is installed on the handle and the like in particular in order to attach to a doorknob, a door mirror and the like as explained above, for which high reliability on external connection, etc. and miniaturization and also environmental performance for shock, vibration and temperature, humidity are being required.

This invention is an art, which belongs to the second antenna coil 31 in Patent Document 1 and the purpose is to provide an antenna coil with simplicity in structure, cheapness and miniature type, which is equipped with reliability on external connection, etc. to satisfy above described requirements.

In order to solve above described problems, the antenna coil relating to this invention is provided with a thin bar-shaped core, a flat, recessed and insulated bobbin of which one side is open, and an insulated exterior case, with a recessed cross section on one side which is bigger than the bobbin and is open, stores the core in a recessed part of the bobbin, is provided with a coil in which the winding is provided on the winding groove formed in the bobbin, stores the coil in a recessed part of the exterior case and fills the adhesive made of resin with high flexibility.

Also, a circuit pattern to which a tuning condenser and a harness for external connection are connected electrically is installed on the bobbin at the end of the longitudinal direction of the bobbin.

In addition, a protruded part to move the harness for external connection around the circuit pattern almost Ω-like and to draw out to the outside is prepared inside the exterior case.

The antenna coil relating to this invention is provided with the structure and means described above and displays the following effects. That is to say, as the core is stored in a recessed part of the bobbin, the coil of which winding groove formed in the bobbin is wound is stored in a recessed part of the exterior case and the adhesive made of resin with high flexibility is filled, there is an effect to make a structure in which the sealed coil and core are hard to be affected with the deteriorating factors under the environmental performances of temperature, humidity, shock, vibration and the like. Also, there is an effect to enable stabilized transmission and reception annulling the changes in inductance by length of the harness as the circuit pattern is prepared in the bobbin and the tuning condenser and the harness for external connection are connected electrically.

In addition, as the harness is inserted along the side of the protruded part prepared inside the exterior case and the inner wall of the exterior case, and the shape is moved around in Ω-like, the coming-off of the harness can be prevented. In this way, the antenna coil in this invention has an effect to realize a cheap and miniature type antenna coil, which has a built-in tuning condenser, prevents the coming-off by using the harness, can inject and fill the adhesive made of resin with high flexibility from the opening by means of the bobbin with the recessed part and the exterior case, makes the drying easy, of which manufacturing method is easy and the structure is simple and the reliability on external connection is enhanced.

### BRIEF DESCRIPTION OF THE DRAWINGS

The objects and features of the invention will become apparent from the following description taken in conjunction with the preferred embodiment thereof with reference to the accompanying drawings in which:

FIG. 1 is a perspective view showing the mode of working of the antenna coil relating to this invention.

FIG. 2 is a decomposition view showing the mode of working of the antenna coil relating to this invention and (a) is a perspective view of the core, (b) is a perspective view of the bobbin in which the core is stored, (c) is a perspective view of the coil of which winding groove is wounded and (d) is a perspective view of the exterior case.

FIG. 3 is a block diagram of the keyless entry device of the vehicle in prior art.

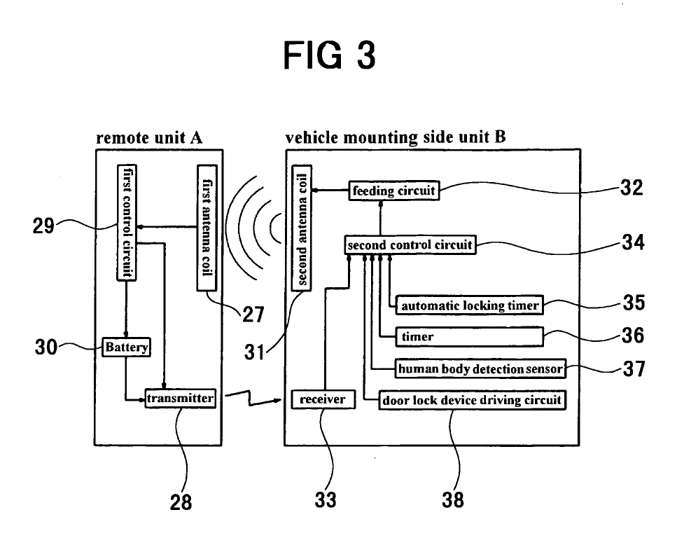

### DETAILED DESCRIPTION OF THE PREFERRED EMBODIMENT

The antenna coil relating to this invention is provided with a core made of thin, bar-shaped ferrite, stores the core in a flat, recessed and insulated bobbin of which one side is open, winds a winding groove formed in the bobbin, has a coil part, which connects a tuning condenser and a harness for external connection electrically in a circuit pattern prepared at the end of the longitudinal direction of the bobbin, which is stored in an insulated exterior case with a recessed cross section on one side which is open. The harness is moved around almost Ω-like along the protruded part prepared inside the exterior case and the inner wall of the case and drawn out to the outside and the spaces between the core and the bobbin and between the winding part and the inner wall of the exterior case are sealed using an adhesive of resin with high flexibility.

Hereinafter, a working example of the antenna coil relating to this invention is explained according to the attached drawings.

The antenna coil relating to this invention corresponds to the second antenna coil 31 to be used in Patent Document 1, which transmits the electromagnetic wave for activation of the remote unit possible for electromagnetic inductive coupling with the first antenna coil 27 when the first antenna coil 27 is in a fixed range to the second antenna coil 31, that is to say, when the scope of magnetic field is within about 1 m from the second antenna coil 31. The operating frequency to be used is 125 KHz.

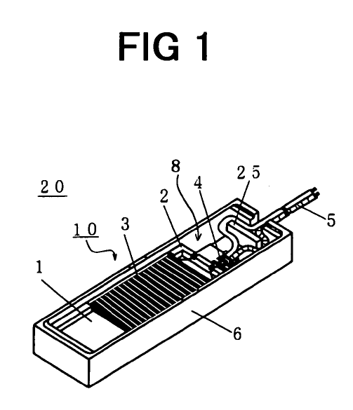

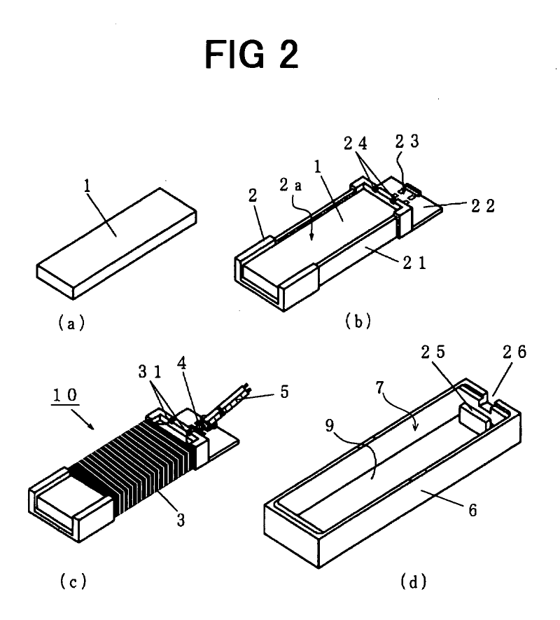

FIG. 1 shows a perspective view of the antenna coil relating to one mode of working in this invention. FIG. 2 shows a perspective decomposition view of the antenna coil shown in FIG. 1.

The antenna coil 20 is shown in FIG. 1 and FIG. 2. Core 1 is formed with thin, flat ferromagnetic substance as shown in FIG. 2(a). Core 1 is stored in a recessed part 2a of bobbin 2 formed with insulated heatproof resin as shown in FIG. 2(b). Core 1 and bobbin 2 may be fixed temporarily using the adhesive. And an insulated and coated wire is wound on winding groove 21 of bobbin 2 to make winding 3. As shown in FIG. 2(c), lead 31 of winding 3 (second antenna coil) is connected electrically to circuit pattern 23 prepared in extension part 22 in one side of bobbin 2 by means of soldering and the like along wiring groove 24 prepared in bobbin 2. Tuning condenser 4 and the harness for external connection 5 are connected on circuit pattern 23 electrically by means of soldering and the like to form coil 10.

Exterior case 6 is a case made of insulated resin with a recessed cross section on one side, which is bigger than bobbin 2 and is open as shown in FIG. 2(d). Wiring groove 26 is prepared in one short side of opening face 7 and protruded part 25 is prepared inside wiring groove 26.

As shown in FIG. 1, coil 10 is stored in recessed part 9 in exterior case 6, which is bigger than bobbin 2, and harness 5 is moved around almost in Ω-like and held with the side of protruded part 25 and the inner wall of long side of the exterior case and is drawn out along the wiring groove 26 in antenna coil 20. In this way, the antenna coil with high reliability in which no influence is given on the connected part with circuit pattern 23 even when a pulling power is applied from the outside by drawing out harness 5 using the protruded part, can be made.

An adhesive is injected from opening 7 of exterior case 6 in which coil 10 is stored, to the upper face of opening 7 to make core 1 of coil 10, and is permeated in winding 3 and bobbin 2 and also is filled in a space between bobbin 2 and inner wall of exterior case 6 and dried in antenna coil 20. In this way, antenna coil 20 relating to this invention can be suitable one for vibration, shock or environmental features such as temperature, humidity and the like by filling the inside coil 10 and the space between coil 10 and exterior case 6 with adhesive. In addition, a thin and flat lid made of resin may be installed as a need arises, though it is not illustrated.

It is desirable for core 1 to use high strength, high magnetic permeability Mn/Zn system ferrite with excellent pressure characteristics, Ni/Zn system ferrite or amorphous magnetic substance and the like. The thin bar-shape rather than the round shape is desirable as a shape taking the mounting into consideration. The relative permeability of core 1 is made to be over 1,000, so that the change in sensitivity by dispersion of the relative permeability can be lessened. The optimum condition of 10 mm long, 5 mm wide and 3 mm thick was deduced as a dimension of core 1 to be minimum in shape in the antenna coil in the working example.

It is desirable for bobbin 2 and exterior case 6 to use the material with insulation-resistance, heat-proof, chemical-resistance or water-proof, for example, heat-proof ABS and the like. The circuit pattern 5 prepared in the bobbin may be the one in which a lead-frame, etc. is buried simultaneously in casting the bobbin previously, or the one in which common printed substrates are glued for use, if the pattern that can be connected is prepared.

Adhesive 8 should have a function to fix core 1, winding 3 and bobbin 2, fill a space of inner wall of exterior case 6 and be a structure in which sealed coil 10 is hard to be subject to the deteriorating factors in environmental performances such as temperature, humidity, shock, vibration and the like. Also, adhesive 8 may be a material full of flexibility and with pressure to be applied on core 1 in hardening, and urethane system resin with shock and vibration absorbing, insulation resistant, chemical resistant and water-proof functions is preferable

In this way, the inventor repeats various examinations on antenna coil 20 relating to this invention and tries to obtain the optimum conditions for core 1 to be the smallest, considering the magnetic permeability and winding (inductance) of core 1 for transmitting the electromagnetic wave to activate the remote unit enables electromagnetic inductive coupling, when the scope of magnetic field is within the scope of about 1 m from the antenna coil, first of all, by analysis of the electromagnetic field in inductive electromagnetic field in order to satisfy electric requirement feature toward the miniaturization.

Core 1 is formed with thin bar-shaped ferrite and core 1 is stored in flat, recessed and insulated bobbin 2 of which one side is open, and winding 3 is provided on winding groove 21 formed in bobbin 2. Coil 10 in which tuning condenser 4 and the harness for external connection 5 are connected electrically on circuit pattern 23 prepared at one end part of bobbin 2, is stored in insulated exterior case 6 with the recessed cross section on one side which is open. Harness 5 is moved around almost in Ω-like along protruded part 25 prepared inside exterior case 6 and inner wall of the case and is drawn out to outside. Accordingly, antenna coil 20 with high reliability in which no influence is given to the connected part with circuit pattern 23 by harness 5 through a pulling power from outside, can be made.

In addition, it can be suitable one for vibration, shock or environmental features such as temperature, humidity and the like by sealing the space between core 1 and bobbin 2 and the space between winding 3 and inner wall of exterior case 6 with adhesive 8 made of resin with high flexibility. As one side is open in both bobbin 2 and exterior case 6, the storing work of core 1 and bobbin 2, and coil 10 and exterior case 6 become easy, the injection of adhesive 8 becomes easy, the drying becomes easy and a cheap and miniature type antenna coil in the simple structure to improve the working performance can be made.

1. An antenna coil, which is provided with a thin bar-shaped core, a flat, recessed and insulated bobbin of which one side is open, and an insulated exterior case with a recessed cross section on one side which is bigger than the bobbin and is open, stores the core in a recessed part of the bobbin, is provided with a coil in which the winding is provided on the winding groove formed in the bobbin, stores the coil in a recessed part of the exterior case and fills the adhesive made of resin with high flexibility.

2. An antenna coil, which is provided with a thin bar-shaped core, a flat, recessed and insulated bobbin of which one side is open, and an insulated exterior case with a recessed cross section on one side, which is bigger than the bobbin and is open. The bobbin is provided with a circuit pattern at the end of the longitudinal direction and a wiring groove and the core is stored in a recessed part in the bobbin, the winding is provided on the winding groove formed in the bobbin, a coil to which a tuning condenser and a harness for external connection are connected electrically is provided in the circuit pattern, the coil is stored in a recessed part in the exterior case and the adhesive made of resin with high flexibility is filled.

3. The antenna coil described in claim 1 or 2 in which the exterior case is provided with a protruded part inside.

4. The antenna coil described in claim 3 in which the harness is moved around in almost Ω-shape along the side of the protruded part of the exterior case and the inner wall surface of the exterior case and is drawn out to outside.
